(19) United States
(12) Patent Application Publication
(10) Pub. No.: US 2001/0026844 A1
(43) Pub. Date: Oct. 4, 2001

(54) Method and device for depositing a coating on a substrate by spraying a liquid

(76) Inventors: Martin Hruschka, Korntal-Muenchingen (DE); Ulrich Hasenkox, Ditzingen (DE)

Correspondence Address: KENYON & KENYON, One Broadway, New York, NY, 10004, US

(21) Appl. No.: 09/795,797

(22) Filed: Feb. 28, 2001

(30) Foreign Application Priority Data
Feb. 29, 2000 (DE) 100 09 598.4-45

(51) Int. Cl. B05D 1/34; B05D 3/06

(52) U.S. Cl. 427/426; 427/551; 427/553; 118/304

(57) ABSTRACT

A method for depositing a ceramic coating on a substrate by spraying a liquid. To accomplish this, first a first coating solution and at least one further coating solution are sprayed and react chemically when they are brought together. The reaction product thus formed forms the coating on the substrate or is converted into the coating in a subsequent further process step. The device has a spray device that ensures that the first coating solution and the further coating solution are brought together immediately before spraying or during spraying itself in the spray device. Alternatively, the device has a first spray device and at least one further spray device, so that the coating solutions are brought together and the reaction that forms the reaction product takes place after spraying on the substrate has occurred.

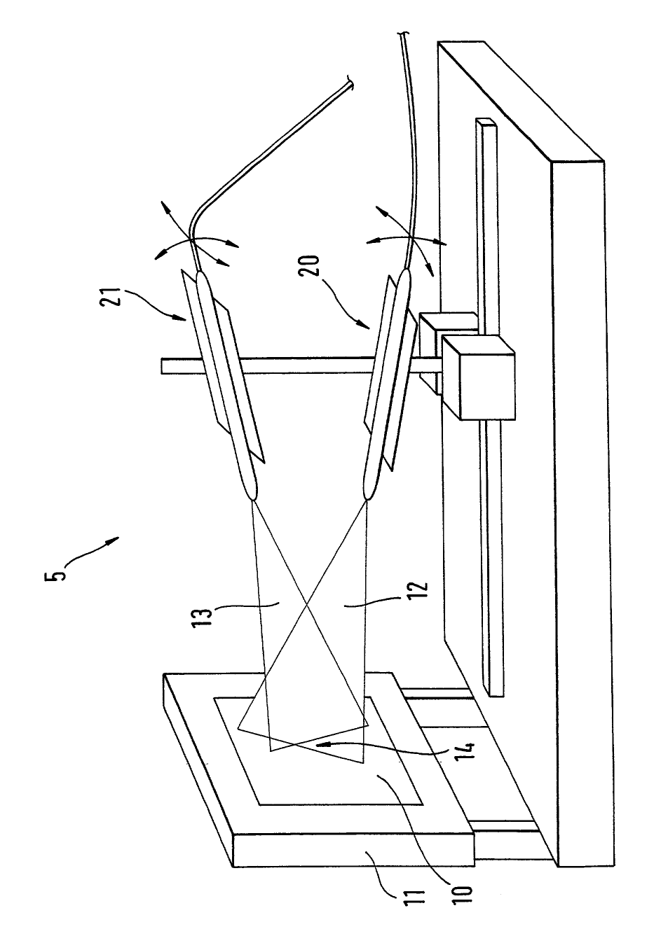

### FIELD OF THE INVENTION

The present invention relates to a method and a device for depositing a coating, in particular a ceramic coating, on a substrate by spraying a liquid.

### BACKGROUND INFORMATION

Protective layers made of advanced ceramic materials in the form of coatings are used to reduce friction and wear and tear in order to minimize energy losses resulting from friction and to minimize wear and tear resulting from abrasion and corrosion. Coatings of this kind display high mechanical hardness levels, are able to withstand high temperatures, and are chemically stable with respect to corrosive media.

A number of methods for depositing coatings of this kind can be used, for example, the sol-gel method, sputter deposition, plasma spraying, and PVD or CVD methods. Wet-chemical production methods, in which coating solutions are first synthesized and then applied to the substrate to be coated via immersion or spin-on deposition, also can be used.

Thus for example Progress in Advanced Materials and Mechanics 1, Beijing, China, 1996, pages 570-573, by K. Pae et al., describes a method for producing nanocrystalline TiO₂ particles via gas-flow condensation. Furthermore, as discussed in Chemical Letters 5, 1998, pages 791-794, by F. Kirkbir et al., titanium isopropoxide can be converted into TiO₂ particles in a tube reactor using water vapor. Furthermore, the article J. Am. Ceram. Soc., 80, (4), 1997, pages 982-990 by V. Belov et al., describes the production of ZrO₂ particles by injecting a zirconium-containing solution into an aqueous ammonia solution. Furthermore, the article “Sol-gel Coatings on Metals”, J. Sol-Gel Science and Technology, 8 (1997), pages 443 to 449, by M. Guglielmi, provides an overview of wet-chemical coatings on metals, used in particular to provide protection against corrosion.

The disadvantages of the aforementioned methods are as follows: Very high process temperatures are required in some cases, which means the basic material to be coated or substrate is subjected to substantial thermal load, which tends to be detrimental in terms of its mechanical properties.

Furthermore, wet chemical methods have the following disadvantage: First a wet film of a prepared coating solution is created and must subsequently be dried and converted into the actual coating at high temperatures. Herein, the substrate to be coated has to be subjected to substantial thermal load, which also involves relatively high energy costs.

To achieve layer thicknesses of just a few micrometers as required for many applications, it is often necessary to immerse the component to be coated in the coating solution a plurality of times or to perform a spin-on deposition process a plurality of times. Multiple coatings of this kind give rise to a large number of defects due to external influences, and also require considerably longer production time.

Furthermore, if relatively thick wet films are applied in just one process step, these films often subsequently undergo significant shrinkage accompanied by formation of cracks.

An object of the present invention is to provide a method and a device that can be used to deposit coatings, in particular ceramic coatings, primarily used to prevent corrosion and/or protect against wear and tear and having a wide variety of compositions on a substrate at as low a temperature as possible via a wet chemical method.

### SUMMARY OF THE INVENTION

The method according to the present invention for depositing a coating, which is based on the principle of reactive spraying, and the device according to the present invention, have the following advantage over the related art: Ceramic coatings in particular having a wide variety of compositions can be deposited on a surface to be coated at low process temperatures via a wet chemical method inexpensively, and, if necessary, as part of continuous production.

The method according to the present invention also has the following advantage: Coatings which cannot be directly deposited from an already prepared ready solution because, for example, when the reactive components are brought together in the solution, insoluble or poorly soluble compounds are formed which then cannot be deposited or can only be deposited on the component to be coated with considerable difficulty in terms of processes, can be synthesized on a substrate or achieved via the reaction product or precursor material, which is not produced until spraying occurs. Furthermore, in the aforementioned situation, in many cases undesirable high temperatures are required to create the desired ceramic structure of the coating.

Altogether, the method according to the present invention has the following key advantage: The wide variety of reactive components that can be used as coating solutions can be handled separately.

A further advantage of the method according to the present invention is that the reaction product deposited on the substrate is created from just a few and in most cases from just two coating solutions, whereas known ready prepared coating solutions often include a large number of reactive components.

Furthermore, it is advantageous that a solid material can be created directly as the reaction product which is already present on the substrate as a solid coating following spraying, or in a subsequent further process step it can be converted into the coating to be created via an aftertreatment, in particular a heat treatment or irradiation that increases density.

In addition, because the individual reactive components, or coating solutions can be stored separately and mixed or brought together in a targeted and controlled manner so as to create a reaction product or precursor material directly on the surface of the substrate to be coated, or immediately before spraying or during spraying itself, one does not encounter process-related difficulties that may arise from the fact that ready-mixed coating solutions may have a limited life or may only be usable for a limited time, or may cause clogging and/or contamination of the spray device being used.

The device according to the present invention also has the advantage that one can use known techniques and spray devices, which only need to be modified slightly.

Thus it is advantageous that the device according to the present invention for atomizing the coating solution has a spray device having a jet or a spray head. This jet, or spray head is based, for example, on an electrostatic operating principle, ultrasound, or an ink-jet method. In addition, a carrier gas may also be used. In the case of the spray device used, one does not necessarily have to use just one jet or spray head, but rather it may be useful to use a plurality of jets which may largely be arranged as desired and may be mounted on swiveling holders at a variable distance from the surface of the substrate.

In order to carry out the heat treatment or irradiation in the further process step, which is used to compact and/or convert the precursor material, or reaction product deposited in the first process step into the coating to be created, one may use a wide variety of methods that are known per se and are easily achievable in technical terms. Thus the heat treatment or irradiation may be carried out using a furnace, an infrared or UV lamp, with the help of a laser, a microwave source, or an electron beam, or in general by heating the substrate via resistance or induction. Herein, it is useful that when the reaction product or the precursor material initially produced is converted into the coating to be created via the further process step, the process temperatures to which the substrate must be subjected are typically between 50° C. and 400° C., i.e., always far below the thermal loadability of, for example, metallic substrates.

Furthermore, it is particularly useful if the reactive components used as coating solutions at least largely are not brought together until they reach the surface of the substrate to be coated, so that their chemical reaction does not occur until then.

### BRIEF DESCRIPTION OF THE DRAWING

The FIGURE shows a schematic diagram of a spray device according to an embodiment of the present invention having two separate spray heads, each spraying on a liquid.

### DETAILED DESCRIPTION

Below, a first exemplary embodiment is explained with the help of the FIGURE. Spray apparatus 5, which has first spray device 20 and second spray device 21, which are separate and can be controlled separately, are provided. Spray devices 20, 21 are arranged on an automated controllable swiveling support. Furthermore, the distance between first and second spray devices 20, 21 and substrate 11 to be coated can be adjusted. In addition, first and/or second spray device 20, 21, can be moved with the help of a control unit so that substrate 11 is sprayed evenly.

As shown in the FIGURE, first coating solution 12 is conveyed to spray device 20 and a second coating solution as further coating solution 13 is conveyed to second spray device 21. The two coating solutions 12, 13 are each separately sprayed onto substrate 11, which can be, for example a steel cylinder, a pump piston or an aluminum or plastic component, via the corresponding spray devices 20, 21, and initially emerge from spray devices 20, 21 in the form of, for example, very finely atomized microscale droplets. These droplets of coating solutions 12, 13 are brought together on substrate 11, a chemical reaction taking place so as to form an initially liquid reaction product in the form of precursor material 14. Herein, the reaction product may have the form of, for example, a suspension of nanoscale particles that have arisen in a solvent remaining as a result of the reaction of coating solutions 12, 13. Precursor material 14 that arises as a result of the chemical reaction between coating solutions 12, 13 thus initially forms an initial product of a subsequently formed solid, for example ceramic coating 10 which is converted into actual coating 10 via a further process step, such as via thermal aftertreatment or irradiation.

Alternatively, when coating solutions 12, 13 are brought together, the chemical reaction between them may also form a solid reaction product straight away which then constitutes the finished coating or is converted into the finished coating via a further process step involving thermal compacting.

Furthermore, atomization of coating solutions 12, 13 in spray apparatus 5 can also be carried out, for example, with the help of a conventional carrier gas, or via an electrostatic atomization technique, ultrasound or an ink-jet system.

As an alternative to the exemplary embodiment shown in the FIGURE, first coating solution 12 and further coating solution 13 can also be brought together immediately before coating solutions 12, 13 are sprayed onto substrate 11. To accomplish this, spray apparatus 5 has just one spray device 20 connected to two separate lines, coating solution 12 and also further coating solution 13 being conveyed via these lines to first spray device 20. Thus coating solutions 12, 13 which are conveyed are mixed inside spray device 20 immediately before spraying occurs, and are sprayed through the jet in this mixed state so that they react with one another during spraying and strike substrate 11 as the reaction product or precursor material 14. In this type of embodiment, first coating solution 12 and further coating solution 13 start to react during spraying itself or immediately before spraying occurs in spray device 20. In this exemplary embodiment, first coating solution 12 may be mixed with further coating solution 13 via a mixing device connected immediately upstream from the actual jet or the actual spray head, or alternatively the two coating solutions 12, 13 may be conveyed directly into the jet or spray head.

It is always important in both proposed exemplary embodiments that first coating solution 12 and further coating solution 13 are not brought together until immediately before or after spraying, so that the chemical reaction between coating solutions 12, 13 takes place immediately before spraying or during spraying itself or after separately sprayed coating solutions 12, 13 strike substrate 11.

Furthermore, in the aforementioned embodiments, first coating solution 12 and further coating solution 13 may be sprayed onto substrate 11 one after the other, in particular in alternating fashion, via first spray device 20 and second spray device 21 respectively, so that they are brought together there in the aforementioned manner and react with one another.

A material that can be converted into a ceramic coating or an organic or inorganic protective layer, in particular a layer that protects against corrosion or wear and tear, or forms a layer of this kind, is suitable as the reaction product or precursor material 14 produced as a result of the chemical reaction that occurs when coating solutions 12, 13 are brought together. Concrete examples of this are materials such as titanium oxide, zirconium oxide, silicon oxide, aluminum oxide, ZrSiO₄, LaPO₄, ZrP₂O₇ and AlPO₄.

Preferably immediately after precursor material 14 has been sprayed onto substrate 11, or alternatively after a solid reaction product has been produced on substrate 11, the reaction product is subjected to heat treatment in a further process step in the area of the sprayed surface, or subjected to irradiation using electromagnetic radiation.

This heat treatment or irradiation may be carried out, for example, via laser radiation lasting a few microseconds or via a conventional furnace process lasting up to several hours. During this heat treatment or irradiation, the reaction product deposited on the surface of substrate 11 is heated to temperatures of between 50° C. and several thousand degrees C, so as, for example, to cause precursor material 14 to be converted into coating 10 to be created or so as to increase the density of a reaction product that has been deposited in solid form. Herein, the temperature of substrate 11 never exceeds values of between 50° C. and 400° C., and preferably does not exceed 300° C.

In addition to a laser or a furnace for the heat treatment or irradiation, an infra-red or UV lamp can be used, or a microwave source or electron beam heating can also be used. Moreover, other generally known resistive or inductive heating principles can be used to heat substrate 11.

It is important to note that substrate 11 is preferably in contact with a specimen holder having an integrated heating means, this specimen holder being either planar or mounted on a rotating mounting opposite spray devices 20, 21.

It is particularly advantageous if heat treatment is carried out with the help of a laser that is integrated into first spray device 20 and/or second spray device 21.

Thus, following the further process step, a coating 10 which typically has a thickness of between 50 nanometers and 500 micrometers is created on substrate 11.

Preferably, with the help of the device explained with reference to the Figure and using the method carried out by the device, coating 10 is created which contains or is made of a metal oxide, in particular silicon oxide, aluminum oxide, titanium oxide, zirconium oxide, a metal carbide, in particular silicon carbide, zirconium carbide, boron carbide or titanium carbide, a metal nitride, in particular silicon nitride, titanium nitride, boron nitride or silicon nitride, a phosphate, in particular of zirconium, titanium, aluminum or one of the lanthanide elements, or a mixture of those materials. Herein, the composition of coating 10 of course depends on the choice of coating solutions 12, 13 used. To produce the aforementioned coatings, for example a solution of easily soluble metal or silicon compounds, in particular reactive metal alkoxides or silanes, are suitable for use as first coating solution 12 and/or further coating solution 13. The solvent is, for example, an alcohol, a carboxylic acid, a ketone, an ester, or water. Water or an inorganic acid or salt solution is suitable as further coating solution 13 to bring about the reaction with first coating solution 12.

In particular, using a first coating solution 12 containing a metal alkoxide and using water as further coating solution 13 has the advantage that, when the metal alkoxide comes into contact with the water, alcohols are split off and the metal alkoxides are condensed, thus forming polymers. By selecting the appropriate quantity of water and alkoxide that is supplied, one can ensure that almost all of this alkoxide is converted into a metal oxide or ceramic.

As the reaction products that are formed from the reaction of the metal alkoxide with the water, in particular water or alcohol, are volatile, ultimately a dense coating which, depending on the process conditions, may range from crystalline to amorphous, can be achieved.

Along with solutions of metal alkoxides, the following, for example, are also suitable as first coating solution 12: solutions having acetates or nitrates of aluminum, zirconium, titanium or one of the lanthanide elements. A solution of a phosphate or a phosphoric acid solution is then added as further coating solution 13 to first coating solution 12. In concrete terms, the following are suitable as first coating solution 12: a ceracetate solution or a zirconium butoxide, while further coating solution 13 is diluted phosphoric acid or an ammonium phosphate solution. In such cases, the two coating solutions 12, 13 which are sprayed on typically react directly on substrate 11, forming an insoluble compound as precursor material 14. Subsequent temperature treatment then causes a ceramic protective layer to be formed as coating 10.

Coating solutions 12, 13 that are supplied may contain not only reactive components that cause the chemical reaction but may also contain solid material in the form of particles, i.e., coating solutions 12, 13 are used as suspensions. This solid material may be the same as the resulting reaction product that is created; alternatively, it may be a different material, so that after coating solutions 12, 13 react chemically to form the reaction product on substrate 11, ultimately a coating 10 is created in which the solid material particles from the coating solution are embedded in a matrix made of a material that is the same as the reaction product or differs therefrom. In this way composite materials can be produced.

Preferably, dry lubricants or materials that reduce shrinkage of coating 10 during thermal aftertreatment or irradiation are suitable as solid material particles in coating solutions 12, 13.

What is claimed is:

1. A method for depositing a coating on a substrate, comprising the steps of:
spraying a first coating solution on the substrate; and
spraying at least one further coating solution on the substrate, the at least one further coating solution being brought together with the first coating solution;
wherein the first coating solution and the at least one further coating solution react chemically when they are brought together, resulting in a reaction product, the reaction product one of forming the coating on the substrate and being converted into the coating during a further treatment process.

2. The method of claim 1, further comprising the steps of:
depositing an initial precursor material on the substrate following spraying, the precursor material formed as the reaction product; and
converting the precursor material into the coating during the further treatment process.

3. The method of claim 1, further comprising the step of:
bringing together the first coating solution and the at least one further coating solution one of immediately before the spraying of the first and at least one further coating solutions and during the spraying of the first and the at least one further coating solutions.

4. The method of claim 1, further comprising the step of:
bringing together the first coating solution and the at least one further coating solution substantially after they have been sprayed onto the substrate.

5. The method of claim 1, further comprising the step of:
bringing together the first coating solution and the at least one further coating solution immediately before spraying inside a jet of a spray device, the chemical reaction taking place in the jet of the spray device.

6. The method of claim 1, wherein the first coating solution and the at least one further coating solution are sprayed onto the substrate one of simultaneously and one after the other in alternating fashion, the first coating solution sprayed via a first spray device, the at least one further coating solution sprayed via a second spray device.

7. The method of claim 1, wherein the coating is a ceramic coating.

8. The method of claim 1, further comprising the steps of:
bringing together the first coating solution and the at least one further coating solution immediately before spraying;
mixing the first coating solution with the at least one further coating solution into a mixture, the chemical reaction then taking place; and
conveying the mixture immediately thereafter to a spray device which sprays the mixture onto the substrate.

9. The method of claim 2, wherein the precursor material is initially deposited in the form of a suspension on the substrate.

10. The method of claim 2, wherein one of the following occurs:
a) the reaction product is deposited on the substrate, forming one of a ceramic coating, an organic coating and an inorganic coating; and
b) one of the reaction product and the precursor material is converted into one of a ceramic coating, an organic coating and an inorganic coating during the further treatment process.

11. The method of claim 10, wherein the one of the ceramic coating, the organic coating and the inorganic coating forms a layer that protects against one of corrosion and wear and tear.

12. The method according to claim 2, further comprising the step of:
subjecting the one of the reaction product and the precursor material to one of heat treatment and irradiation using electromagnetic radiation in the further treatment process.

13. The method of claim 12, wherein the step of subjecting the one of the reaction product and the precursor material to one of heat treatment and irradiation occurs immediately after spraying of the first coating solution and the at least one further coating solution has occurred.

14. The method of claim 1, wherein at least one of the first coating solution and the at least one further coating solution are solutions of easily soluble compounds, the compounds being one of metal compounds and silicon compounds.

15. The method of claim 14, wherein the metal compounds are reactive metal alkoxides and the silicon compounds are silanes.

16. The method of claim 13, wherein the heat treatment is carried out at temperatures of between 50° C. and 400° C.

17. The method of claim 16, wherein the heat treatment is carried out at temperatures between 90° C. and 300° C.

18. The method of claim 1, wherein the at least one further coating solution is one of water and a solution of at least one compound, the at least one compound including at least one of metal compounds and silicon compounds.

19. The method of claim 18, wherein the metal compounds are metal alkoxides and the silicon compounds are silanes.

20. A device for depositing a coating on a substrate by spraying a liquid, comprising:
a first spray device to which a first coating solution and at least one further coating solution can be conveyed, the first spray device including a mixing arrangement for bringing together the first coating solution and the at least one further coating solution one of immediately before spraying and during spraying, the first coating solution and the at least one further coating solution reacting chemically to form a reaction product when brought together.

21. The device of claim 20, wherein the reaction product is a precursor material.

22. The device of claim 20, further comprising:
at least one further spray device, the at least one further coating solution being conveyed to the at least one further spray device, the first coating solution being conveyed to the first spray device;
wherein the first and the at least one further spray device are arranged so that the first coating solution and the at least one further coating solution are brought together substantially after spraying has occurred.

23. The device of claim 20, further comprising:
an arrangement, the arrangement providing for at least one of heat treatment and irradiation of the substrate.

24. The device of claim 20, wherein the mixing arrangement is one of a jet, a spray head and a supply line, the supply line feeding one of the jet and the spray head.

25. The device of claim 22, wherein at least one of:
a) at least one of the first spray device and the at least one further spray device is movable; and
b) the substrate is arranged on a substrate carrier, the substrate carrier being able to move relative to at least one of the first spray device and the at least one further spray device.
